(19) United States
(12) Patent Application Publication
(10) Pub. No.: US 2010/0079410 A1
(43) Pub. Date: Apr. 1, 2010

(54) THREE-DIMENSIONAL TOUCH INTERFACE

(75) Inventor: Wayne Christopher MINTON, Lund (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/241,272

(22) Filed: Sep. 30, 2008

(51) Int. Cl. G06F 3/042; G06F 3/041

(52) U.S. Cl. 345/175; 345/173

(57) ABSTRACT

A device includes a flexible display, and multiple tactile components provided adjacent to a bottom of the flexible display. The device also includes a movement device configured to move at least one of the multiple tactile components to engage a portion of the bottom of the flexible display to produce a tactile area on the flexible display.

### BACKGROUND

Devices, such as mobile communication devices (e.g., cell phones, personal digital assistants (PDAs), etc.), include touch sensitive input devices (e.g., touch sensitive interfaces or displays). Touch sensitive displays are usually formed with either a resistive or capacitive film layer located above an input display that is used to sense a touch of the user's finger or stylus. Humans are very adept at using tactile feedback to assess their surroundings. However, it is difficult to use such touch sensitive displays without physically viewing the displays because the touch sensitive displays are flat and provide no tactile feedback to users.

### SUMMARY

According to one implementation, a user device may include a flexible display, multiple tactile components provided adjacent to a bottom of the flexible display, and a movement device configured to move at least one of the multiple tactile components to engage a portion of the bottom of the flexible display to produce a tactile area on the flexible display.

Additionally, the user device may include a sensor configured to sense a user depression of the tactile area provided on the flexible display, and a processor configured to execute a function associated with the tactile area based on the user depression.

Additionally, the sensor may include multiple sensor elements associated with the multiple tactile components and being configured to sense movement of the multiple the tactile components towards and away from the flexible display.

Additionally, each of the multiple sensor elements may include one of a mechanical motion detector, an optical motion detector, an acoustical motion detector, or a pressure sensor.

Additionally, the sensor may be further configured to provide, to the processor, information associated with the user depression, and the processor may be further configured to execute a function associated with the tactile area based on the information associated with the user depression.

Additionally, the user device may include one of a mobile communication device, a laptop computer, a personal computer, a camera, a video camera, binoculars, a telescope, or a portable gaming device.

Additionally, the flexible display may include one of a color flexible display or a monochrome flexible display.

Additionally, the flexible display may include a thin film transistor (TFT) liquid crystal display (LCD).

Additionally, the thin film transistor (TFT) liquid crystal display (LCD) may include a plastic substrate with a metal foil, multiple thin film transistors (TFT) arranged on the metal foil, and a color filter coated onto the plastic substrate, where the color filter may be configured to display color images.

Additionally, each of the multiple tactile components may include a pin formed from a transparent substance.

Additionally, each of the multiple tactile components may be sized and shaped to engage a portion of the flexible display that is substantially a size of a pixel displayed by the flexible display.

Additionally, the multiple tactile components may be arranged adjacent to a portion of the bottom of the flexible display.

Additionally, a number of the multiple tactile components and a flexibility of the flexible display may determine a level of detail capable of being provided for the tactile area.

Additionally, the movement device may include multiple movement elements associated with the multiple tactile components and being configured to mechanically move the multiple tactile components towards and away from the bottom of the flexible display.

Additionally, each of the multiple movement elements may include one of a mechanical actuator, a piezoelectric actuator, an electro-mechanical actuator, or a linear motor.

Additionally, the processor may be further configured to provide, to the movement device, information associated with formation of the tactile area, and the movement device may be further configured to move the at least one of the multiple tactile components to produce the tactile area based on the information associated with formation of the tactile area.

According to another implementation, a method may include providing a flexible screen for a display of a user device, providing multiple tactile components adjacent to the flexible screen, and moving at least one of the multiple tactile components to engage a portion of a bottom of the flexible screen to produce a tactile area on the flexible screen.

Additionally, the method may include sensing a user depression of the tactile area provided on the flexible screen, and executing a function associated with the tactile area based on the user depression.

Additionally, the method may include receiving information associated with formation of the tactile area, and producing the tactile area based on the information associated with formation of the tactile area.

According to yet another implementation, a system may include means for providing a flexible screen for a display of a user device, means for providing multiple tactile components adjacent to the flexible screen, means for moving at least one of the multiple tactile components to engage a portion of a bottom of the flexible screen to produce a tactile area on the flexible screen, means for sensing a user depression of the tactile area provided on the flexible screen, and means for executing a function associated with the tactile area based on the user depression.

### BRIEF DESCRIPTION OF THE DRAWINGS

The accompanying drawings, which are incorporated in and constitute a part of this specification, illustrate one or more systems and/or methods described herein and, together with the description, explain these systems and/or methods. In the drawings:

FIG. 1 depicts an exemplary diagram of a user device in which systems and/or methods described herein may be implemented;

FIG. 2 illustrates a diagram of exemplary components of the user device depicted in FIG. 1;

FIG. 3 depicts an isometric view of the user device illustrated in FIG. 1 and shows tactile and non-tactile areas of a display of the user device;

FIGS. 4A and 4B illustrate diagrams of exemplary components of the display of the user device depicted in FIG. 1;

FIGS. 5A and 5B depict diagrams of exemplary components of a movement device of the display illustrated in FIGS. 4A and 4B;

FIGS. 6A-6C illustrate diagrams of exemplary components of a sensor of the display depicted in FIGS. 4A and 4B;

FIGS. 7A and 7B depict diagrams of an exemplary operation associated with the display illustrated in FIGS. 4A and 4B; and

FIG. 8 illustrates a flow chart of an exemplary process for operating the user device depicted in FIG. 1 according to implementations described herein.

### DETAILED DESCRIPTION

The following detailed description refers to the accompanying drawings. The same reference numbers in different drawings may identify the same or similar elements. Also, the following detailed description does not limit the invention.

### Overview

Systems and/or methods described herein may provide a device with a three-dimensional touch interface (e.g., a touch screen display). The touch screen display may include a flexible screen and a series of tactile components (e.g., pins) that can be controlled to push up from underneath the flexible screen and create tactile areas (e.g., three-dimensional areas) on the flexible screen. The three-dimensional touch screen display may provide a unique experience for users, and may enable users to manipulate (e.g., via tactile feedback provided by the tactile areas) the touch screen display without viewing the display. For example, in one implementation, the systems and/or methods may provide a flexible screen for a display of a user device, and may provide one or more tactile components adjacent to the flexible screen. The systems and/or methods may move the one or more tactile components to engage a portion of the flexible screen and to produce a tactile (e.g., three-dimensional) area on the flexible screen. The systems and/or methods may sense a user depression of the tactile area, and may execute a function associated with the tactile area based on the user depression.

A “user device,” as the term is used herein, is intended to be broadly interpreted to include a mobile communication device (e.g., a radiotelephone, a personal communications system (PCS) terminal that may combine a cellular radiotelephone with data processing, a facsimile, and data communications capabilities, a personal digital assistant (PDA) that can include a radiotelephone, pager, Internet/intranet access, web browser, organizer, camera, a Doppler receiver, and/or global positioning system (GPS) receiver, a GPS device, a telephone, a cellular phone, etc.); a laptop computer; a personal computer; a printer; a facsimile machine; a pager; a camera (e.g., a contemporary camera or a digital camera); a video camera (e.g., a camcorder); a calculator; binoculars; a telescope; a GPS device; a portable gaming device; any other device capable of utilizing a touch screen display; a thread or process running on one of these devices; and/or an object executable by one of these devices.

The term “user,” as used herein, is intended to be broadly interpreted to include a user device or a user of a user device.

### Exemplary User Device Configuration

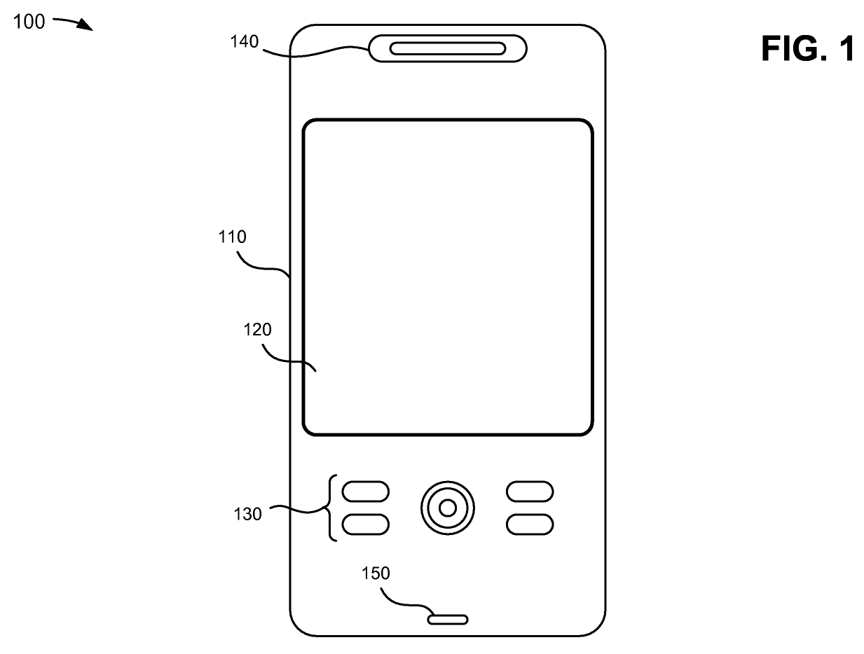

FIG. 1 depicts an exemplary diagram of a user device 100 in which systems and/or methods described herein may be implemented. As illustrated, user device 100 may include a housing 110, a display 120, control buttons 130, a speaker 140, and/or a microphone 150.

Housing 110 may protect the components of user device 100 from outside elements. Housing 110 may include a structure configured to hold devices and components used in user device 100, and may be formed from a variety of materials. For example, housing 110 may be formed from plastic, metal, or a composite, and may be configured to support display 120, control buttons 130, speaker 140, and/or microphone 150.

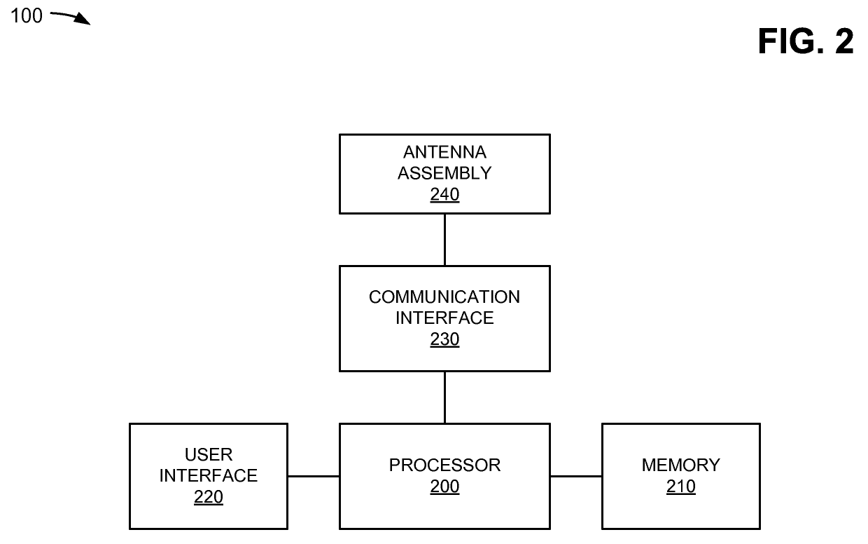

Display 120 may provide visual information to the user. For example, display 120 may display text input into user device 100, text, images, video, and/or graphics received from another device, and/or information regarding incoming or outgoing calls or text messages, emails, media, games, phone books, address books, the current time, etc. In one implementation, display 120 may include a touch screen display that may be configured to receive a user input when the user touches display 120. For example, the user may provide an input to display 120 directly, such as via the user's finger, or via other devices, such as a stylus. User inputs received via display 120 may be processed by components and/or devices operating in user device 100. The touch screen display may permit the user to interact with user device 100 to cause user device 100 to perform one or more operations. Further details of display 120 are provided below in connection with, for example, FIGS. 2-7B.

Control buttons 130 may permit the user to interact with user device 100 to cause user device 100 to perform one or more operations. For example, control buttons 130 may be used to cause user device 100 to transmit and/or receive information (e.g., to display a text message via display 120, raise or lower a volume setting for speaker 140, etc.).

Speaker 140 may provide audible information to a user of user device 100. Speaker 140 may be located in an upper portion of user device 100, and may function as an ear piece when a user is engaged in a communication session using user device 100. Speaker 130 may also function as an output device for music and/or audio information associated with games and/or video images played on user device 100.

Microphone 150 may receive audible information from the user. Microphone 150 may include a device that converts speech or other acoustic signals into electrical signals for use by user device 100. Microphone 150 may be located proximate to a lower side of user device 100.

Although FIG. 1 shows exemplary components of user device 100, in other implementations, user device 100 may contain fewer, different, or additional components than depicted in FIG. 1. In still other implementations, one or more components of user device 100 may perform one or more other tasks described as being performed by one or more other components of user device 100.

FIG. 2 illustrates a diagram of exemplary components of user device 100. As illustrated, user device 100 may include a processor 200, a memory 210, a user interface 220, a communication interface 230, and/or an antenna assembly 240.

Processor 200 may include a microprocessor, an application-specific integrated circuit (ASIC), a field-programmable gate array (FPGA), or the like. Processor 200 may control operation of user device 100 and its components. In one implementation, processor 200 may control operation of components of user device 100 in a manner described herein.

Memory 210 may include a random access memory (RAM), a read-only memory (ROM), and/or another type of memory to store data and instructions that may be used by processor 200.

User interface 220 may include mechanisms for inputting information to user device 100 and/or for outputting information from user device 100. Examples of input and output mechanisms might include buttons (e.g., control buttons 130, keys of a keypad, a joystick, etc.) or a touch screen interface (e.g., display 120) to permit data and control commands to be input into user device 100; a speaker (e.g., speaker 140) to receive electrical signals and output audio signals; a microphone (e.g., microphone 150) to receive audio signals and output electrical signals; a display (e.g., display 120) to output visual information (e.g., text input into user device 100); a vibrator to cause user device 100 to vibrate; and/or a camera to receive video and/or images.

Communication interface 230 may include, for example, a transmitter that may convert baseband signals from processor 200 to radio frequency (RF) signals and/or a receiver that may convert RF signals to baseband signals. Alternatively, communication interface 230 may include a transceiver to perform functions of both a transmitter and a receiver. Communication interface 230 may connect to antenna assembly 240 for transmission and/or reception of the RF signals.

Antenna assembly 240 may include one or more antennas to transmit and/or receive RF signals over the air. Antenna assembly 240 may, for example, receive RF signals from communication interface 230 and transmit them over the air, and receive RF signals over the air and provide them to communication interface 230. In one implementation, for example, communication interface 230 may communicate with a network and/or devices connected to a network.

As will be described in detail below, user device 100 may perform certain operations described herein in response to processor 200 executing software instructions of an application contained in a computer-readable medium, such as memory 210. A computer-readable medium may be defined as a physical or logical memory device. The software instructions may be read into memory 210 from another computer-readable medium or from another device via communication interface 230. The software instructions contained in memory 210 may cause processor 200 to perform processes that will be described later. Alternatively, hardwired circuitry may be used in place of or in combination with software instructions to implement processes described herein. Thus, implementations described herein are not limited to any specific combination of hardware circuitry and software.

Although FIG. 2 shows exemplary components of user device 100, in other implementations, user device 100 may contain fewer, different, or additional components than depicted in FIG. 2. In still other implementations, one or more components of user device 100 may perform one or more other tasks described as being performed by one or more other components of user device 100.

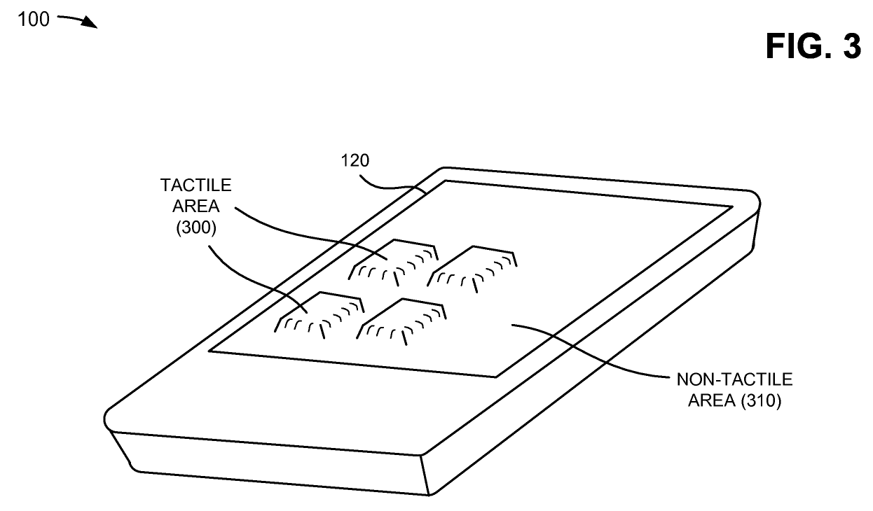

FIG. 3 depicts an isometric view of user device 100. As shown in FIG. 3, display 120 of user device 100 may include one or more tactile areas 300 and/or a non-tactile area 310.

Tactile areas 300 may include three-dimensional areas that extend away from a surface of display 120 so that a user may receive tactile feedback from tactile areas 300. Tactile areas 300 may display a variety of information, such as information associated with operation of user device 100 (e.g., text, numbers, icons, graphics, etc.). Tactile areas 300 may include a variety of shapes, colors, and/or sizes. For example, if user device 100 displays icons, tactile areas 300 may be shaped, colored, and/or sized to conform to the shapes, colors, and/or sizes associated with the icons. In another example, if user device 100 displays numbers or text, tactile areas 300 may be shaped and/or sized to conform to the shapes and/or sizes associated with the numbers or text. Tactile areas 300 may be associated with functions capable of being performed by device 100. For example, if one of tactile areas 300 displays an icon associated with the Internet, depression of the icon-related tactile area may cause device 100 (e.g., via processor 200) to access the Internet. In another example, if one of tactile areas 300 displays a number associated with a telephone keypad, depression of the number-related tactile area may cause device 100 (e.g., via processor 200) to dial the number.

Non-tactile area 310 may include an area that forms a non-tactile (flat or substantially flat) surface of display 120. Non-tactile area 310 may display a variety of information, such as information associated with operation of user device 100 (e.g., text, numbers, icons, graphics, etc.). A user may not receive tactile feedback from non-tactile area 310, but may view the variety of information displayed by non-tactile area 310.

Although FIG. 3 shows exemplary components of user device 100, in other implementations, user device 100 may contain fewer, different, or additional components than depicted in FIG. 3. In still other implementations, one or more components of user device 100 may perform one or more other tasks described as being performed by one or more other components of user device 100.

### Exemplary Display Configuration

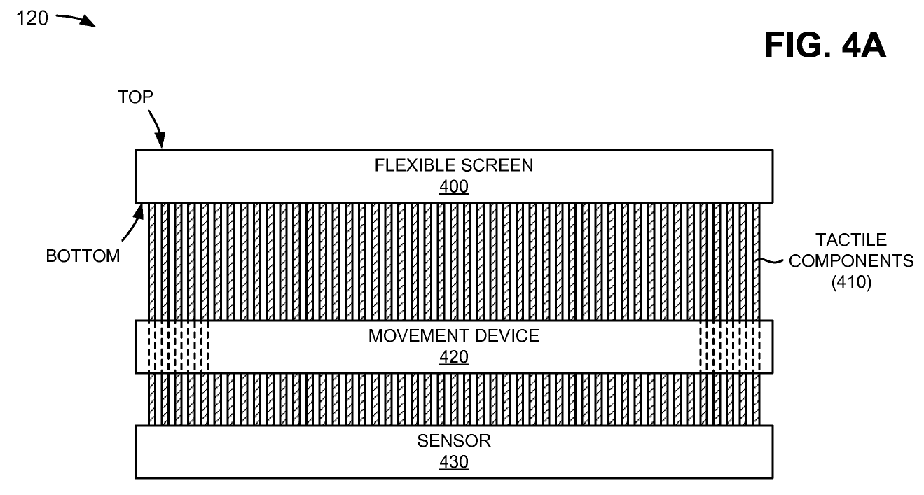

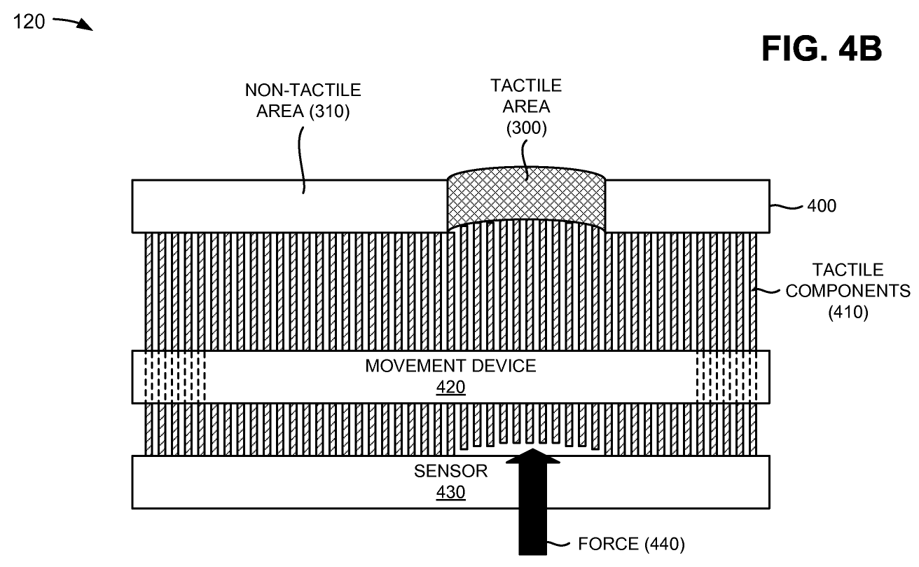

FIGS. 4A and 4B illustrate diagrams of exemplary components of display 120. As illustrated, display 120 may include a flexible screen (or display) 400, one or more tactile components 410, a movement device 420, and/or a sensor 430.

Flexible screen 400 may include any device capable of providing visual information (e.g., text, images, video, incoming or outgoing calls, games, phone books, the current time, emails, etc.) to a user. For example, flexible screen 400 may include a flexible liquid crystal display (LCD), such as a thin film transistor (TFT) LCD, etc. In one exemplary implementation, flexible screen 400 may include a plastic substrate that arranges TFT on a metal foil (rather than on glass), which may permit flexible screen 400 to recover its original shape after being bent. Flexible screen 400 may include a color filter coated onto the plastic substrate, which may permit flexible screen 400 to display color images. In other implementations, flexible screen 400 may include a monochrome, flexible LCD.

In one implementation, flexible screen 400 may include any number of color and/or monochrome pixels. In another implementation, flexible screen 400 may include a passive-matrix structure or an active-matrix structure. In a further implementation, if flexible screen 400 is a color array, each pixel may be divided into three cells, or subpixels, which may be colored red, green, and blue by additional filters (e.g., pigment filters, dye filters, metal oxide filters, etc.). Each subpixel may be controlled independently to yield numerous possible colors for each pixel. In other implementations, each pixel of flexible screen 400 may include more or less than three subpixels of various colors other than red, green, and blue.

Each of tactile components 410 may include a rigid mechanism (e.g., a pin) that may engage a portion of the bottom of flexible screen 400, and may provide an upward force on the portion of flexible screen 400. Tactile components 410 may be controlled (e.g., via processor 200 and/or movement device 420) to push up from underneath flexible screen 400 and create tactile areas (e.g., tactile areas 300) on flexible screen 400. Tactile components 410 may include a variety of shapes, sizes, and/or arrangements. For example, each of tactile components 410 may be sized and/or shaped to engage a portion of flexible screen 400 that is a size of or substantially a size of a pixel displayed by flexible screen 400. In other examples, each of tactile components 410 may be sized and/or shaped to engage a portion of flexible screen that is a size larger than a size of a pixel displayed by flexible screen 400. In one implementation, tactile components 410 may be arranged to engage (or be adjacent to) a portion of the bottom of flexible screen 400, the entire bottom of flexible screen 400, substantially the entire bottom of flexible screen 400, etc. The number of tactile components 410 and the flexibility of flexible screen 400 may determine a level of detail capable of being provided for tactile areas 300. For example, as the number of tactile components 410 and the flexibility of flexible screen 400 increases, the level detail provided for tactile areas 300 may increase.

Tactile components 410 may be made from a variety of materials. For example, tactile components 410 may be made from a rigid material (e.g., plastic, metal, glass, crystal, etc.). In one exemplary implementation, tactile components 410 may be formed of a transparent substance, such as indium tin oxide, so as to allow light (e.g., emitted from a backlight) to pass up through flexible screen 400 and be visible to the user.

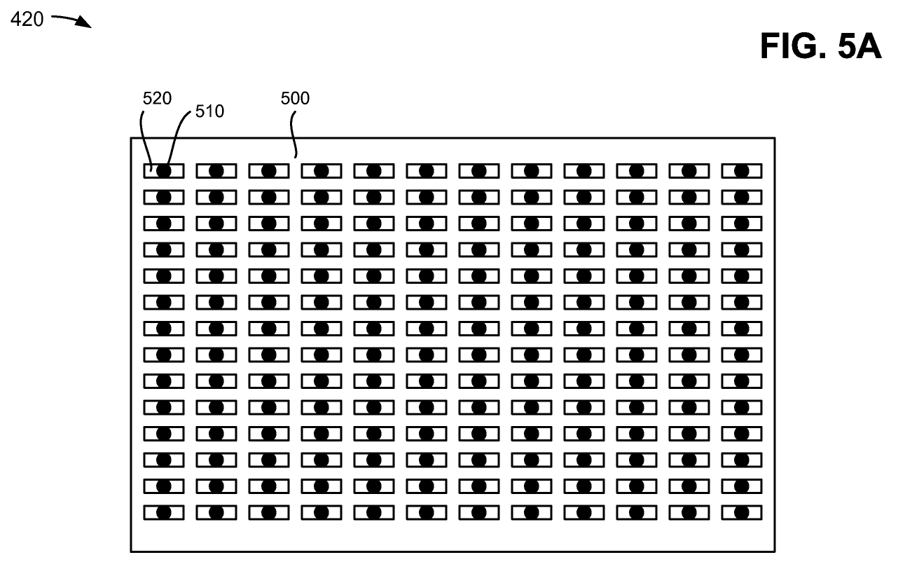

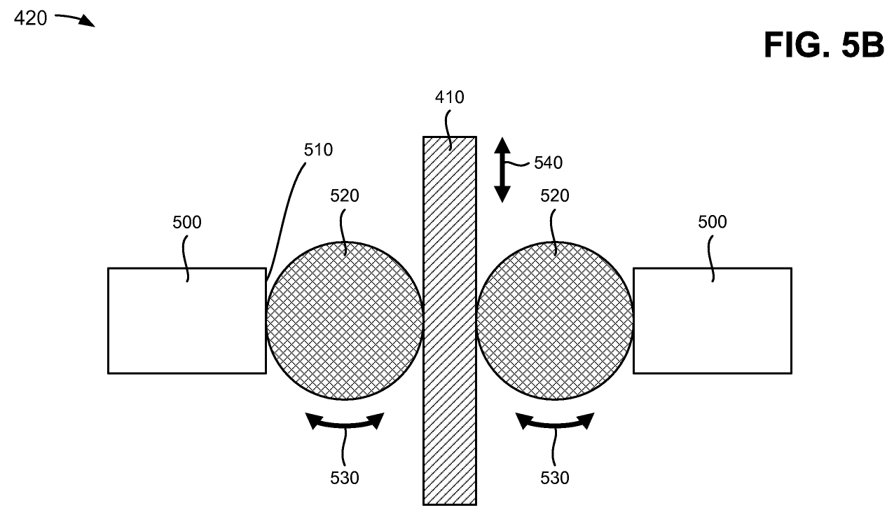

Movement device 420 may include a device that mechanically moves tactile components 410 towards and/or away from the bottom portion of flexible screen 400. In one implementation, movement device 420 may include one or more devices (e.g., a linear actuator), associated with corresponding tactile components 410, that impart force and motion, in a linear manner, on the corresponding tactile components 410. For example, movement device 420 may include one or more mechanical actuators, piezoelectric actuators, electro-mechanical actuators, linear motors, etc. Movement device 420 may be made from a variety of materials. In one exemplary implementation, components of movement device 420 may be formed of a transparent substance, such as indium tin oxide, so as to allow light (e.g., emitted from a backlight) to pass up through flexible screen 400 and be visible to the user. Further details of movement device 420 are provided below in connection with, for example, FIGS. 5A and 5B.

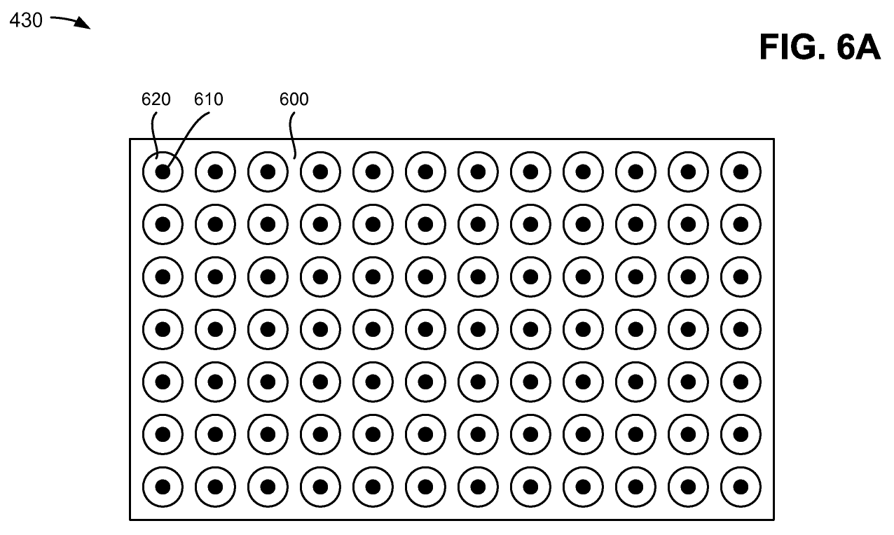

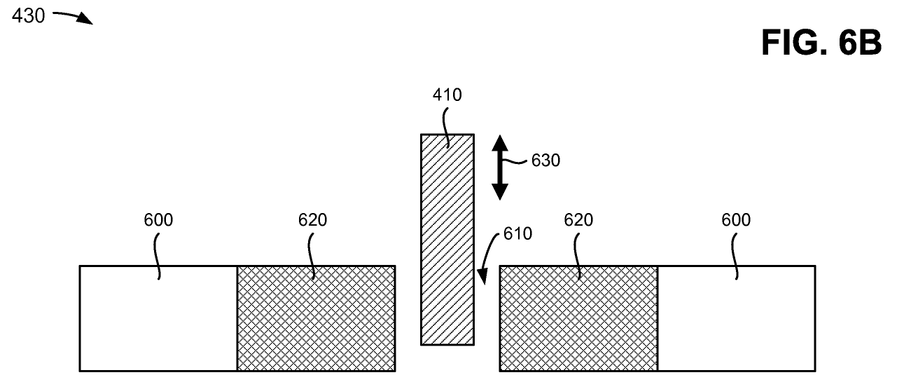

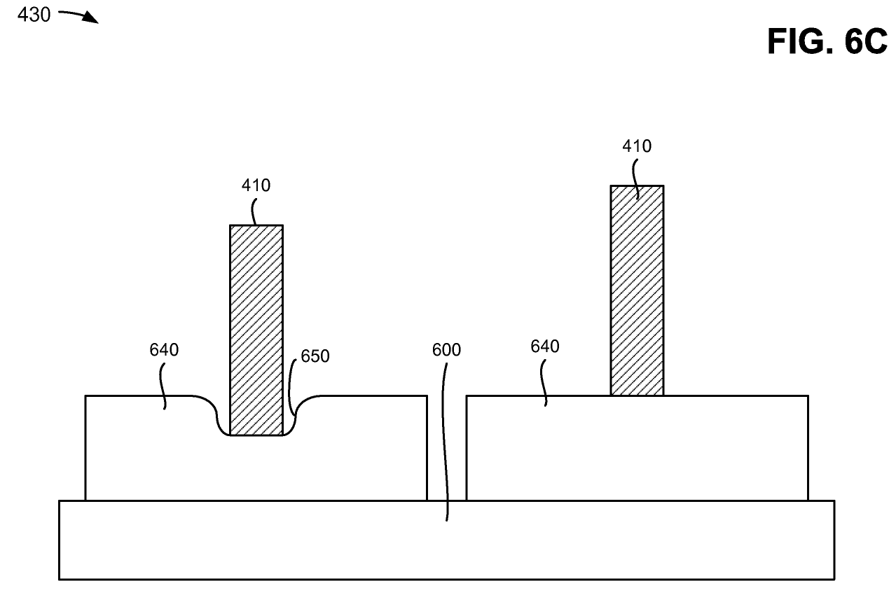

Sensor 430 may include a device that senses movement of tactile components 410 towards and/or away from flexible screen 400. In one implementation, sensor 430 may include one or more optical devices, associated with corresponding tactile components 410, which may optically sense movement of tactile components 410 towards and/or away from flexible screen 400. In other implementations, sensor 430 may include a pressure sensor that may sense movement of tactile components 410 towards and/or away from flexible screen 400 based on pressure applied by tactile components 410 on sensor 430. The movement detected by sensor 430 may enable device 100 (e.g., via processor 200) to determine where tactile areas 300 are formed on flexible screen 400, and when to execute the functions associated tactile areas 300. For example, if one of tactile areas 300 is associated with an icon for a word processing application, depression of the icon-related tactile area may cause movement of tactile components 410 associated with the icon-related tactile area. Sensor 430 may detect this movement, and may provide this information to processor 200. Processor 200 may receive this information, and may execute the word processing application. Sensor 430 may be made from a variety of materials. In one exemplary implementation, components of sensor 430 may be formed of a transparent substance, such as indium tin oxide, so as to allow light (e.g., emitted from a backlight) to pass up through flexible screen 400 and be visible to the user. Further details of sensor 430 are provided below in connection with, for example, FIGS. 6A-6C.

As further shown in FIG. 4A, in one implementation, tactile components 410 may be provided adjacent to (or may engage) the bottom portion of flexible screen 400, may extend through movement device 420, and may be provided adjacent to (or may engage) sensor 430. In other implementations, tactile components 410, movement device 420, and/or sensor 430 may be arranged in a different manner depending upon the components making up movement device 420 and/or sensor 430.

As shown in FIG. 4B, movement device 420 may apply a force 440 that moves certain tactile components 410 in an upward direction towards flexible screen 400 to produce tactile area 300 in flexible screen 400. The remainder of tactile components 410 may remain in place under non-tactile area 310 of flexible screen 400. For example, if tactile area 300 corresponds to a tactile icon, device 100 (e.g., via processor 200) may send a signal to movement device 420 that may provide information relating to formation of the tactile icon. Movement device 420 may receive the signal information, and may move certain tactile components 410 (e.g., based on the signal information) in an upward direction towards flexible screen 400 to produce the tactile icon. Although FIG. 4B shows a single tactile area 300, in other implementations, movement device 420 may manipulate tactile components 410 to produce multiple tactile areas 300.

Although FIGS. 4A and 4B show exemplary components of display 120, in other implementations, display 120 may contain fewer, different, or additional components than depicted in FIGS. 4A and 4B. For example, display 120 may include a light (e.g., a backlight) that may provide backlighting to a lower surface of flexible screen 400 in order to display information. The light may employ light emitting diodes (LEDs) or other types of devices to illuminate portions of flexible screen 400. The light may also be used to provide front lighting to an upper surface of flexible screen 400 that faces a user. In still other implementations, one or more components of display 120 may perform one or more other tasks described as being performed by one or more other components of display 120.

### Exemplary Movement Device Configuration

FIGS. 5A and 5B depict diagrams of exemplary components of movement device 420. As shown in FIG. 5A (a top plan view), movement device 420 may include a body portion 500 that includes multiple openings 510 and movement elements 520 associated with openings 510. In one implementation, each opening 510/movement element 520 combination may be associated with a corresponding tactile component 410.

Body portion 500 may include a substrate that is capable of supporting and/or retaining movement elements 520 around openings 510 provided through body portion 500. Body portion 500 may be sized and/or shaped to accommodate a number of openings 510 that correspond to the number of tactile components 410. In one implementation, body portion 500 may be formed of a transparent substance, such as indium tin oxide, so as to allow light (e.g., emitted from a backlight) to pass up through flexible screen 400 and be visible to the user.

Openings 510 may be provided through body portion 500, and may be sized and/or shaped to accommodate the size and/or shape of tactile components 410. Although FIG. 5A shows circular openings 510, in other implementations, openings 510 may be in another shape (e.g., square, rectangular, triangular, oval, etc.).

Each of movement elements 520 may include a device that mechanically moves tactile components 410 towards and/or away from the bottom portion of flexible screen 400. In one implementation, each of movement elements 520 may include a device (e.g., a linear actuator) that imparts force and motion, in a linear manner, on a corresponding tactile component 410. For example, each of movement elements 520 may include a mechanical actuator, a piezoelectric actuator, an electro-mechanical actuator, a linear motor, etc.

In one exemplary implementation, as shown in FIG. 5B (a partial side view), movement element 520 may include a pair of mechanical wheels that may be rotated (e.g., simultaneously) in a clockwise or counterclockwise direction, as indicated by reference number 530. As the wheels rotate, the wheels may provide a force 540 on tactile component 410 that moves tactile component 410 in an upward direction or a downward direction. For example, if the wheels rotate in a counterclockwise direction, tactile component 410 may be moved in an upward direction (e.g., towards flexible screen 400). If the wheels rotate in a clockwise direction, tactile component 410 may be moved in a downward direction (e.g., away from flexible screen 400).

In other implementations, movement element 520 may include devices that impart magnetic fields on tactile component 410 to move tactile component 410 in an upward direction or a downward direction. In such an arrangement, tactile component 410 may be formed of a material that is responsive to the magnetic fields generated by the devices imparting the magnetic fields.

Although FIGS. 5A and 5B show exemplary components of movement device 420, in other implementations, movement device 420 may contain fewer, different, or additional components than depicted in FIGS. 5A and 5B. In still other implementations, one or more components of movement device 420 may perform one or more other tasks described as being performed by one or more other components of movement device 420.

### Exemplary Sensor Configuration

FIGS. 6A-6C illustrate diagrams of exemplary components of sensor 430. As shown in FIG. 6A (a top plan view), sensor 430 may include a body portion 600 that includes multiple openings 610 and sensor elements 620 associated with openings 510. In one implementation, each opening 610/sensor element 620 combination may be associated with a corresponding tactile component 410.

Body portion 600 may include a substrate that is capable of supporting and/or retaining sensor elements 620 around openings 610. Body portion 600 may be sized and/or shaped to accommodate a number of openings 610 that correspond to the number of tactile components 410. In one implementation, body portion 600 may be formed of a transparent substance, such as indium tin oxide, so as to allow light (e.g., emitted from a backlight) to pass up through flexible screen 400 and be visible to the user.

Openings 610 may be provided through or partially through body portion 500, and may be sized and/or shaped to accommodate the size and/or shape of tactile components 410. Although FIG. 6A shows circular openings 610, in other implementations, openings 610 may be in another shape (e.g., square, rectangular, triangular, oval, etc.).

Each of sensor elements 620 may include a device that measures movement of a corresponding tactile component 410. In one implementation, each of sensor elements 620 may include a device (e.g., a motion detector) that detects movement of a corresponding tactile component 410. For example, each of sensor elements 620 may include a mechanical motion detector, an electronic motion detector, etc.

In one exemplary implementation, as shown in FIG. 6B (a partial side view), sensor element 620 may include an optical transmitter/receiver pair (or an acoustical transmitter/receiver pair) provided within opening 610. As tactile component 410 moves in an upward direction (e.g., towards flexible screen 400) or a downward direction (e.g., away from flexible screen 400), as indicated by directional arrow 630, the optical (or acoustical) transmitter/receiver pair may detect movement of tactile component 410. Sensor element 620 may convey movement information associated with tactile component 410 to other components of device 100 (e.g., to processor 200). Such movement information, for example, may provide an indication of tactile area 300 (e.g., an icon) being provided on flexible screen 400, selection of tactile area 300 (e.g., a user's selection of the icon may cause tactile components 410 to move), etc.

In another exemplary implementation, as shown in FIG. 6C (a partial side view), openings 610 and sensor elements 620 may be omitted from sensor 430, and multiple pressure sensors 640 may be associated with corresponding tactile components 410. Pressure sensors 640 may be provided on base portion 600 and may be sized and/or shaped to accommodate the size and/or shape of tactile components 410. For example, in one implementation, pressure sensors 640 may be circular in shape. In other implementations, pressure sensors 640 may be in another shape (e.g., square, rectangular, triangular, oval, etc.).

Each of pressure sensors 640 may include a device that measures pressure applied by a corresponding tactile component 410. The pressure applied by the corresponding tactile component 410 may provide an indication of the movement of the corresponding tactile component 410. In one implementation, each of pressure sensors 640 may include a device (e.g., a strain gauge, a semiconductor piezoresistive pressure sensor, a micromechanical system, etc.) that detects pressure applied by a corresponding tactile component 410. As further shown in FIG. 6C, the left tactile component 410 may apply a pressure to the left pressure sensor 640 (e.g., as shown by a deflection 650 in pressure sensor 640), and the right tactile component 410 may not apply a pressure to the left pressure sensor 640.

Although FIGS. 6A-6C show exemplary components of sensor 430, in other implementations, sensor 430 may contain fewer, different, or additional components than depicted in FIGS. 6A-6C. In still other implementations, one or more components of sensor 430 may perform one or more other tasks described as being performed by one or more other components of sensor 430.

### Exemplary Display Operation

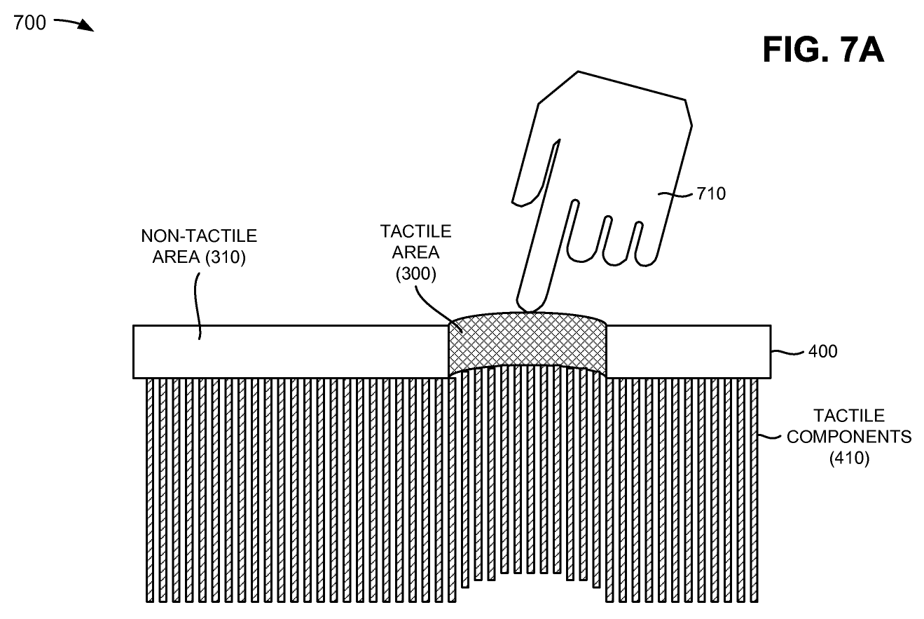

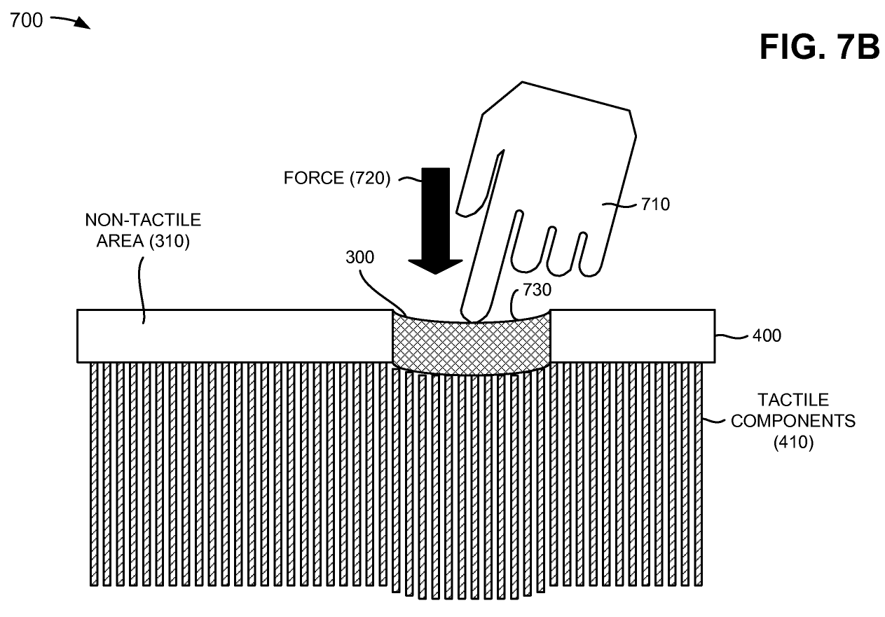

FIGS. 7A and 7B depict diagrams of an exemplary operation 700 associated with display 120. As illustrated in FIG. 7A, display 120 may include flexible screen 400 (e.g., that includes tactile area 300 and non-tactile area 310) and tactile components 410. Tactile area 300, non-tactile are 310, flexible screen 400, and/or tactile components 410 may include the features described above in connection with, for example, FIGS. 3-4B. As further shown in FIG. 7A, a user 710 (e.g., a user of user device 100) may sense (e.g., may receive tactile feedback from) tactile area 300 with one or more fingers. The tactile feedback provided by tactile area 300 may indicate to user 710 that a function associated with tactile area 300 may be available to user 710.

As shown in FIG. 7B, if user 710 wishes to activate the function associated with tactile area 300, user 710 (e.g., via one or more fingers) may apply a downward force 720 to tactile area 300. In response to force 720, tactile area 300 may form a depression 730 in flexible screen 400. Depression 730 of tactile area 300 may cause one or more tactile components 410 associated with tactile area 300 to move in a downward direction toward sensor 430 (not shown). Sensor 430 may sense the downward movement of the one or more tactile components 410, and may provide this information to processor 200. Processor 200 may receive the information, and may execute the function associated with tactile area 300. For example, if tactile area 300 displays an icon associated with a text messaging application, depression 730 of tactile area 300 may cause device 100 (e.g., via processor 200) to execute the text messaging application.

In other implementations, tactile components 410 may be connected to the bottom portion of flexible screen 400, and may apply a force on flexible screen 400 in a downward direction to create one or more tactile areas (e.g., depressions or ridges) in flexible screen 400. The depression/ridges may be associated with a function in a similar manner that tactile area 300 is associated with a function. In such an arrangement, if user 710 wishes to activate the function associated with the depressions/ridges, user 710 (e.g., via one or more fingers) may apply a downward force to the depressions/ridges. The downward force may cause one or more of tactile components 410 associated with the depressions/ridges to move further in a downward direction toward sensor 430. Sensor 430 may sense the downward movement of the one or more tactile components 410, and may provide this information to processor 200. Processor 200 may receive the information, and may execute the function associated with depressions/ridges.

In still other implementations, non-tactile area 310 may be associated with one or more functions of device 100. For example, non-tactile area 310 may be manipulated by user 710 (e.g., via one or more fingers) to zoom, pan, rotate, etc. information displayed by flexible screen 400. In such an arrangement, manipulation of non-tactile area 310 may cause movement of one or more tactile components 410. Sensor 430 may sense movement of the one or more tactile components 410, and may provide this information to processor 200. Processor 200 may receive the information, and may execute the function (e.g., zoom, pan, rotate, etc.) associated with non-tactile area 310.

Although FIGS. 7A and 7B show exemplary components and/or operations of display 120, in other implementations, display 120 may contain fewer, different, or additional components than depicted in FIGS. 7A and 7B, and may perform different or additional operations than depicted in FIGS. 7A and 7B. In still other implementations, one or more components of display 120 may perform one or more other tasks described as being performed by one or more other components of display 120.

### Exemplary Process

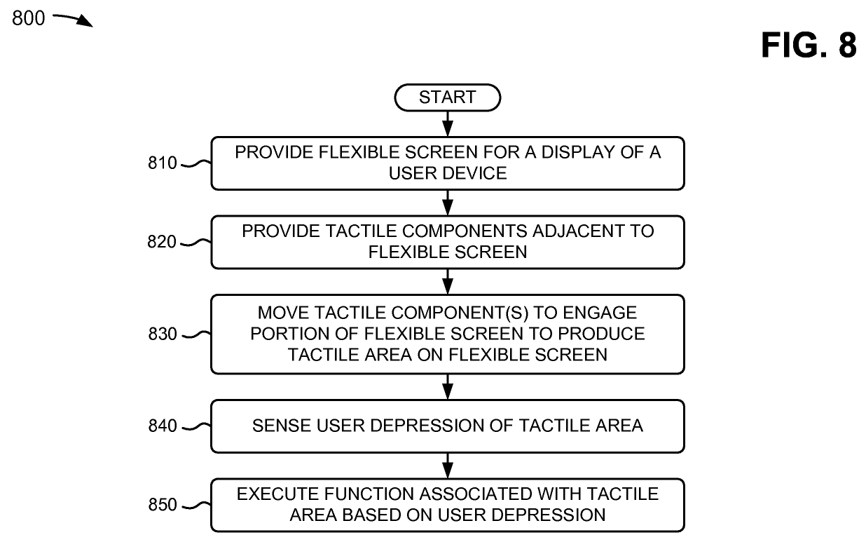

FIG. 8 depicts a flow chart of an exemplary process 800 for operating user device 100 according to implementations described herein. In one implementation, process 800 may be performed by hardware, software, or a combination of hardware and software components of user device 100 (e.g., display 120, processor 200, etc.). In other implementations, process 800 may be performed by hardware, software, or a combination of hardware and software components of user device 100 in combination with hardware, software, or a combination of hardware and software components of another device (e.g., communicating with user device 100 via communication interface 230).

As illustrated in FIG. 8, process 800 may begin with providing a flexible screen for a display of a user device (block 810), and providing one or more tactile components adjacent to the flexible screen (block 820). For example, in implementations described above in connection with FIG. 4, display 120 of user device 100 may include flexible screen 400 and one or more tactile components 410. Flexible screen 400 may include any device capable of providing visual information (e.g., text, images, video, incoming or outgoing calls, games, phone books, the current time, emails, etc.) to a user. In one example, flexible screen 400 may include a flexible liquid crystal display (LCD), such as a thin film transistor (TFT) LCD, etc. Each of tactile components 410 may include a rigid mechanism (e.g., a pin) that may engage (or be adjacent to) a portion of the bottom of flexible screen 400, and may provide an upward force on the portion of flexible screen 400. In one example, tactile components 410 may be arranged to be adjacent to a portion of the bottom of flexible screen 400, the entire bottom of flexible screen 400, substantially the entire bottom of flexible screen 400, etc.

Returning to FIG. 8, the one of the one or more tactile components may be moved to engage a portion of the flexible screen to produce a tactile area on the flexible screen (block 830). For example, in implementations described above in connection with FIG. 4, tactile components 410 may be controlled (e.g., via processor 200 and/or movement device 420) to push up from underneath flexible screen 400 and create tactile areas (e.g., tactile areas 300) on flexible screen 400. Each of tactile components 410 may be sized and/or shaped to engage a portion of flexible screen 400 that is a size of or substantially a size of a pixel displayed by flexible screen 400. In one example, tactile components 410 may be arranged to engage a portion of the bottom of flexible screen 400, the entire bottom of flexible screen 400, substantially the entire bottom of flexible screen 400, etc.

As further shown in FIG. 8, if a user of the user device depresses the tactile area, a user depression of the tactile area may be sensed (block 840), and a function associated with the tactile area may be executed based on the user depression (block 850). For example, in implementations described above in connection with FIG. 7B, if user 710 wishes to activate the function associated with tactile area 300, user 710 (e.g., via one or more fingers) may apply downward force 720 to tactile area 300. In response to force 720, tactile area 300 may form a depression 730 in flexible screen 400. Depression 730 of tactile area 300 may cause one or more tactile components 410 associated with tactile area 300 to move in a downward direction toward sensor 430 (not shown). Sensor 430 may sense the downward movement of the one or more tactile components 410, and may provide this information to processor 200. Processor 200 may receive the information, and may execute the function associated with tactile area 300. In one example, if tactile area 300 displays an icon associated with a text messaging application, depression 730 of tactile area 300 may cause device 100 (e.g., via processor 200) to execute the text messaging application.

### CONCLUSION

Systems and/or methods described herein may provide a device with a three-dimensional touch screen display. The touch screen display may include a flexible screen and a series of tactile components that can be controlled to push up from underneath the flexible screen and create tactile areas on the flexible screen. The three-dimensional touch screen display may provide a unique experience for users, and may enable users to manipulate the touch screen display without viewing the display. For example, in one implementation, the systems and/or methods may provide a flexible screen for a display of a user device, and may provide one or more tactile components adjacent to the flexible screen. The systems and/or methods may move the one or more tactile components to engage a portion of the flexible screen and to produce a tactile area on the flexible screen. The systems and/or methods may sense a user depression of the tactile area, and may execute a function associated with the tactile area based on the user depression.

The foregoing description of implementations provides illustration and description, but is not intended to be exhaustive or to limit the invention to the precise form disclosed. Modifications and variations are possible in light of the above teachings or may be acquired from practice of the invention.

For example, while a series of blocks has been described with regard to FIG. 8, the order of the blocks may be modified in other implementations. Further, non-dependent blocks may be performed in parallel.

It should be emphasized that the term “comprises/comprising” when used in the this specification is taken to specify the presence of stated features, integers, steps or components but does not preclude the presence or addition of one or more other features, integers, steps, components or groups thereof.

It will be apparent that aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Even though particular combinations of features are recited in the claims and/or disclosed in the specification, these combinations are not intended to limit the invention. In fact, many of these features may be combined in ways not specifically recited in the claims and/or disclosed in the specification.

No element, block, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A user device, comprising:
a flexible display;
a plurality of tactile components provided adjacent to a bottom of the flexible display; and
a movement device configured to move at least one of the plurality of tactile components to engage a portion of the bottom of the flexible display to produce a tactile area on the flexible display.

2. The user device of claim 1, further comprising:
a sensor configured to sense a user depression of the tactile area provided on the flexible display; and
a processor configured to execute a function associated with the tactile area based on the user depression.

3. The user device of claim 2, where the sensor comprises a plurality of sensor elements associated with the plurality of tactile components and being configured to sense movement of the plurality of the tactile components towards and away from the flexible display.

4. The user device of claim 3, where each of the plurality of sensor elements comprises one of:
a mechanical motion detector,
an optical motion detector,
an acoustical motion detector, or
a pressure sensor.

5. The user device of claim 2, where the sensor is further configured to provide, to the processor, information associated with the user depression, and
the processor is further configured to execute a function associated with the tactile area based on the information associated with the user depression.

6. The user device of claim 1, where the user device comprises one of:
a mobile communication device;
a laptop computer;
a personal computer;
a camera;
a video camera;
binoculars;
a telescope; or
a portable gaming device.

7. The user device of claim 1, where the flexible display comprises one of a color flexible display or a monochrome flexible display.

8. The user device of claim 1, where the flexible display comprises a thin film transistor (TFT) liquid crystal display (LCD).

9. The user device of claim 8, where the thin film transistor (TFT) liquid crystal display (LCD) comprises:
a plastic substrate with a metal foil,
a plurality of thin film transistors (TFT) arranged on the metal foil, and
a color filter coated onto the plastic substrate, where the color filter is configured to display color images.

10. The user device of claim 1, where each of the plurality of tactile components comprises a pin formed from a transparent substance.

11. The user device of claim 1, where each of the plurality of tactile components is sized and shaped to engage a portion of the flexible display that is substantially a size of a pixel displayed by the flexible display.

12. The user device of claim 1, where the plurality of tactile components are arranged adjacent to a portion of the bottom of the flexible display.

13. The user device of claim 1, where a number of the plurality of tactile components and a flexibility of the flexible display determines a level of detail capable of being provided for the tactile area.

14. The user device of claim 1, where the movement device comprises a plurality of movement elements associated with the plurality of tactile components and being configured to mechanically move the plurality of tactile components towards and away from the bottom of the flexible display.

15. The user device of claim 16, where each of the plurality of movement elements comprises one of:
a mechanical actuator,
a piezoelectric actuator,
an electro-mechanical actuator, or
a linear motor.

16. The user device of claim 1, where:
the processor is further configured to provide, to the movement device, information associated with formation of the tactile area, and
the movement device is further configured to move the at least one of the plurality of tactile components to produce the tactile area based on the information associated with formation of the tactile area.

17. A method, comprising:
providing a flexible screen for a display of a user device;
providing a plurality of tactile components adjacent to the flexible screen; and
moving at least one of the plurality of tactile components to engage a portion of a bottom of the flexible screen to produce a tactile area on the flexible screen.

18. The method of claim 17, further comprising:
sensing a user depression of the tactile area provided on the flexible screen; and
executing a function associated with the tactile area based on the user depression.

19. The method of claim 1, further comprising:
receiving information associated with formation of the tactile area; and
producing the tactile area based on the information associated with formation of the tactile area.

20. A system, comprising:
means for providing a flexible screen for a display of a user device;
means for providing a plurality of tactile components adjacent to the flexible screen;
means for moving at least one of the plurality of tactile components to engage a portion of a bottom of the flexible screen to produce a tactile area on the flexible screen;
means for sensing a user depression of the tactile area provided on the flexible screen; and
means for executing a function associated with the tactile area based on the user depression.
